(19) United States
(12) Patent Application Publication
(10) Pub. No.: US 2005/0222857 A1
(43) Pub. Date: Oct. 6, 2005

(54) Analyzing services provided by means of a communication system

(75) Inventors: Kalevi Kilkki, Espoo (FI); Olli-Pekka Pohjola, (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/915,549

(22) Filed: Aug. 11, 2004

(30) Foreign Application Priority Data
Apr. 5, 2004 (GB) 0407736.8

(51) Int. Cl. G06F 17/60

(52) U.S. Cl. 705/1

(57) ABSTRACT

A method and analyzer analyzes services offered via a communication system A net benefit is determined for a first service based on selected features of the first service. Differences between the selected features of the first service and a second service are then determined. A combined net benefit is then determined based on the net benefit of the first service and the differences between the selected features of the first and second services.

### BACKGROUND OF THE WVENTION

1. Field of the Invention

The present invention relates to a communication system, and in particular, but not exclusively, to analysis of services provided by means of a communication system.

2. Description of the Related Art

A communication system is typically configured to provide communications between two or more entities such as user equipment and/or other nodes associated with the communication system. The communication may comprise, for example, communication of voice, text, data, multimedia and so on. A user equipment connected to a communication system may, for example, be provided with a two-way telephone call or multi-way conference call. A user equipment may also communicate via the communication system with an application providing entity. The application providing entity may comprise, for example, a service provider. A service provider typically provides services by means of at least one application server (AS).

A wide variety of services may be offered via a communications system. The services may be offered by the operator of the communication system, or by a third party service provider. Non-limiting examples of service include voice communication services, data services, messaging services, multimedia services, Push-to-talk services, streaming services, game service and so on, and any combinations of these. Service providers also try to offer services that meet various demands of a diverse user base. Ever increasing number and variety of services is thus offered via communication networks. The services provided are also becoming increasingly complex by their design.

A service provider may need to make numerous decisions on various aspects of the design of services. These aspects could relate, for example, to the product portfolio so that it includes offered products and services, to the properties of the services, and aspects such as pricing, marketing and targeting of the services. The service provider may also need to consider aspects such as network resources including network elements, their capabilities and capacities, and issues relating to Quality of Service (QoS) such as maintained performance level in the network and applied prioritisation, resource allocation, and buffering structures, and so on.

A user may benefit from a choice to use a service if it makes it easier for the user to satisfy his/hers needs. On the other hand, costs of services may vary. One of the issues that may need to be considered when considering the usage of a service is thus how and based on what reasoning the users choose to use their limited resources when attempting to satisfy their needs in a best possible manner. The limited abilities of users, time, and income may restrain users from using a service and/or certain features of a service, even if they might want to use the service or the specific features. Economics of service usage are commonly based on thinking that a user makes choices by weighting the benefits and costs of different options and then selects an option which gives him/her the highest net benefit at a given moment of time. In other words, users may choose to use a service based upon calculations regarding the difference between benefits and costs.

Although cost are commonly understood to mean the total amount of money that the user pays for the use a service, this is not necessarily the entire cost. Cost may also be in the form of any other appropriate consideration. For example, the cost may be something a user values, something which a user may need to be give up or something that causes suffering of some kind due to the choice. In other words, the cost of a selected service is something that is detrimental for a user. Cost of using a service may also include sacrifices such as giving up an opportunity to use limited resources, for example, money and time, for something else. This is sometimes called opportunity cost. The opportunity cost may sometimes be the highest net benefit from alternative choices that must be sacrificed to attain a selected service. The opportunity cost includes also all trouble and inconvenience that a user may face when using a selected service.

Users may have only limited amounts of money and/or time to use on services. Users may have to make choices which services to use and how much to use them. These choices may depend on user's needs and on the aspects of the service provider's general service design, for example on the product portfolio, technical properties of services, pricing, marketing, and quality of service.

The complexity of selection of services is increased by factors that may be beyond the control of users and/or service providers. For example, a communication system may suffer from capacity bottlenecks, for example in links, nodes, or application servers. All services and users that use the limited capacity of the bottleneck affect the service quality experienced by a single user and vice versa.

Advanced Quality of Service (QoS) designs can be used to differentiate products and users, for example to give more resources and thus better service quality to some users or services at the expense of other users or services. Service quality affects user satisfaction and usage of services. Usage then affects the service quality and so on. These all may influence service provider's business in various, often complex ways that are almost impossible to comprehend without appropriate analytical tools.

It might therefore be advantageous to be able to analyse implications of a design of a service to use of services, and to compare the services to assist in selection of a service that is best suited for a user and/or a service provider. For example, it might be advantageous to be able to analyse use of services based on various aspects of design of a service such as technical properties of a service, content of a service, pricing, service quality, availability, usability, service penetration, marketing, market share, and so on. It might also be advantageous to be able to analyse implications of a design of a service to revenue and user net benefit.

### SUMMARY OF THE INVENTION

Embodiments of the present invention aim to address one or several of the above problems.

According to an embodiment of the present invention, there is provided a method for analysing services offered via a communication system. The method comprises the steps of determining a net benefit for a first service based on selected features of the first service, determining differences between selected features of the first service and a second service, and determining a combined net benefit based on the net benefit of the first service and the differences between the selected features of the first and second services.

According to another embodiment there is provided an analyser for analysing services offered via a communication system. The analyser comprises a net benefit analyser for determining a net benefit for a first service based on selected features of the first service and a difference analyser for determining differences between selected features of the first service and a second service. A combiner is provided for determining a combined net benefit based on the net benefit of the first service determined by the net benefit analyser and the differences between the selected features of the first and second services determined by the difference analyser.

The embodiments of the invention may provide a common method to analyse different features of services and a capability of explaining interdependencies between different features of services. Implications of service design aspect to use of services and service providing may be analysed. A tool for assisting in selection of a service may be provided.

### BRIEF DESCRIPTION OF DRAWINGS

For better understanding of the present invention, reference will now be made by way of example to the accompanying drawings in which:

FIG. 1 shows communication system;

FIG. 2 presents the structure of a model which may be used to analyse and optimise service provider's general service design;

FIG. 3 presents how costs and benefits may vary in the progress of time;

FIG. 4 presents a net benefit curve for a service;

FIG. 5 presents a net benefit curve with unit pricing; FIG. 6 is a flowchart illustrating the operation of one embodiment of the present invention;

FIGS. 7a, 7b and 7c present the change from a net benefit curve of a preferred service to a net benefit curve of an offered service due to comparison of benefit and cost differences;

FIG. 8 presents the combined effect of price and service quality to service usage and net benefit;

FIG. 9 presents costs and benefits for preferred services in accordance with an example; and

FIG. 10 presents net benefit curves for offered services of the FIG. 10 example.

### DETAILED DESCRIPTION OF THE PREFERRED EMBODIMENTS

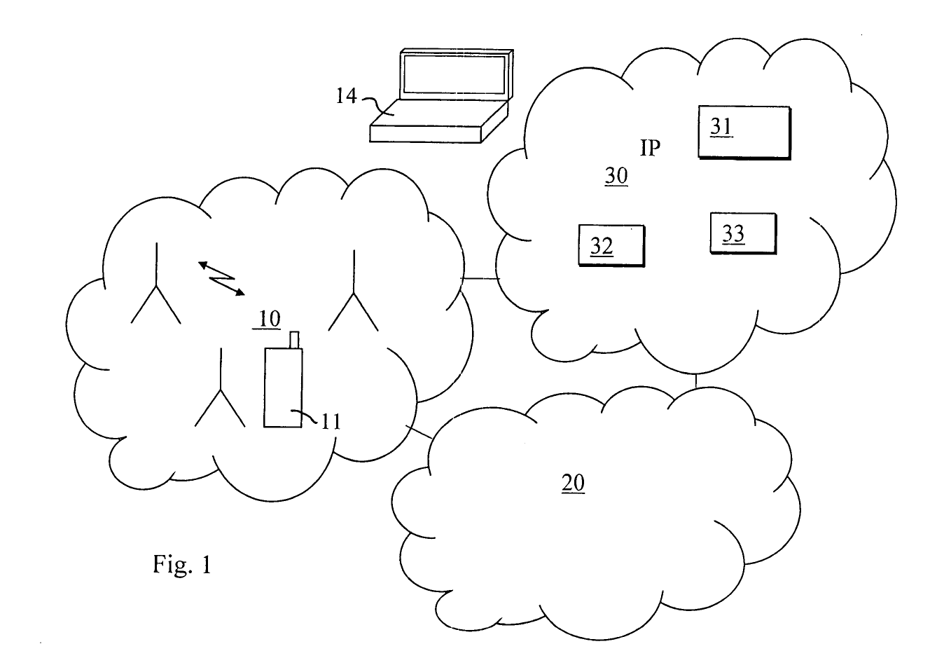

Reference is first made to FIG. 1 which shows a communication systems comprising three different networks 10, 20 and 30. More particularly, the exemplifying communication system comprises a wireless network 10 proving wireless communication for a user equipment 11, a fixed line network 20 and a data network 30. The networks interface each other by appropriate arrangements. For example, one or more gateway nodes may be provided for connecting the communication networks to each other.

In a wireless system such as the network 10 communication occurs on a wireless interface between a user equipment 11 and the elements of the communication system. The wireless communication can be based on an appropriate communication protocol. Wireless systems are commonly referred to as mobile systems. An example of the mobile systems is the public land mobile network (PLMN). A PLMN is commonly based on cellular architecture. In a typical cellular architecture a base transceiver station (BTS) serves mobile stations (MS) or similar mobile user equipment (UE) 11 via an air or radio interface. A base station provides a radio access entity that is typically but not exclusively referred to as a cell. Another example is a mobile system that is based, at least partially, on use of communication satellites. Mobile communications may also be provided by means of other mobile systems, such as by means of wireless local area networks (WLAN).

From the other communication networks the data network 30 may be as an IP (Internet Protocol) and/or other packet switched data network 30. The fixed line network 20 may be any appropriate communication network providing fixed line communications for the users thereof.

The mobile user equipment 11 of FIG. 1 may comprise any appropriate mobile user equipment adapted to connect the network 10. The user equipment is preferably adapted for Internet Protocol (IP) communication with entities locate in the data network 30. For example, the mobile user may access the cellular network by means of a Personal computer (PC), a Personal Data Assistant (PDA), a mobile station (MS) and so on. The following examples are described with reference to mobile stations.

The user equipment 1 may connect, via the communication network 10, to various service provider entities 32, 33 and 34 providing service applications and connected to the data network 30. For example, the user may connect to servers that are generally connected to an external packet data network, for example to an Internet Protocol (IP) network. The data processing functions of the application servers may be provided by means of one or more data processor entities. Appropriately adapted computer program code product may be used for implementing the servers. It shall be appreciated that the user equipment 11 may communicate with application servers provided in different data networks.

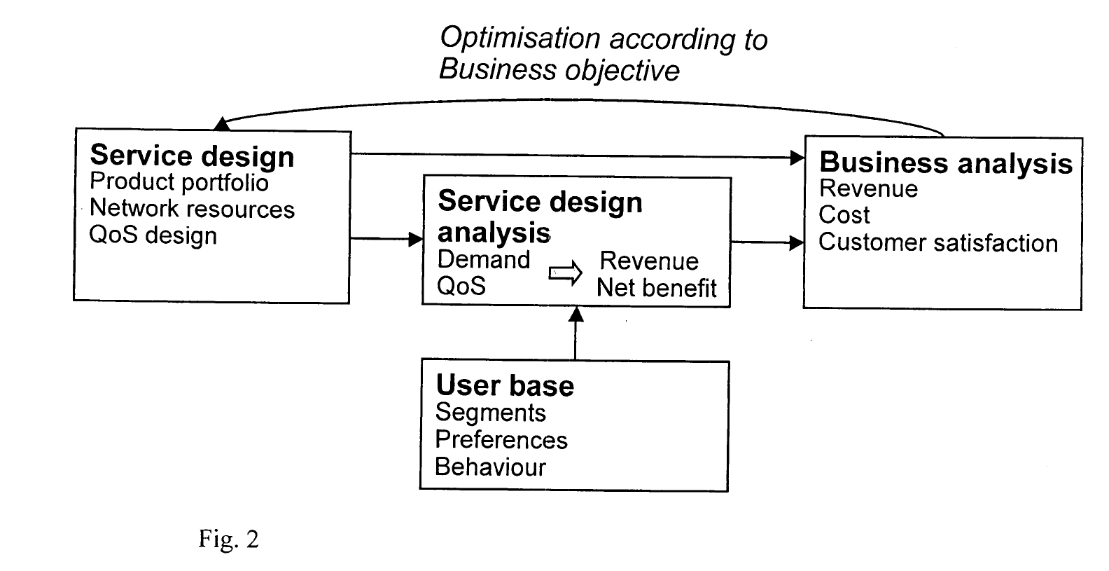

An exemplifying embodiment employing an algorithm for analyzing the implications of various features of a service offered to mobile users regarding the service usage and total net benefit from the service usage will now be described. The features to be analyzed may comprise service features such as technical properties, content, availability, usability, price, quality and so on. The expert system of the embodiment aims to assess all relevant aspects of a design of services within a comprehensive model, at the same time and in a similar manner, as shown in FIG. 2.

The concept may be based on holistic design of services in which objectives of the business may justify all design aspects of the services from pricing to Quality of Service (QoS) design, and offered end-user services to network resources. In an embodiment the expert system may analyze implications of the design of services to business measures, such as revenue, cost, and user satisfaction, which are used to optimize the design of services according to the business objective. Before a more detailed explanation of the embodiment, a brief discussion of possible expectations and behavior of users is given below.

Users may consider anything that brings them closer to the goals they are seeking as beneficial. This goal seeking creates needs, which users may then valuate depending on how good the need is in taking them towards their goals. If a service satisfies the need perfectly, the maximum benefit what users can get from the service equals the value of the need, assuming that the service satisfies only one need.

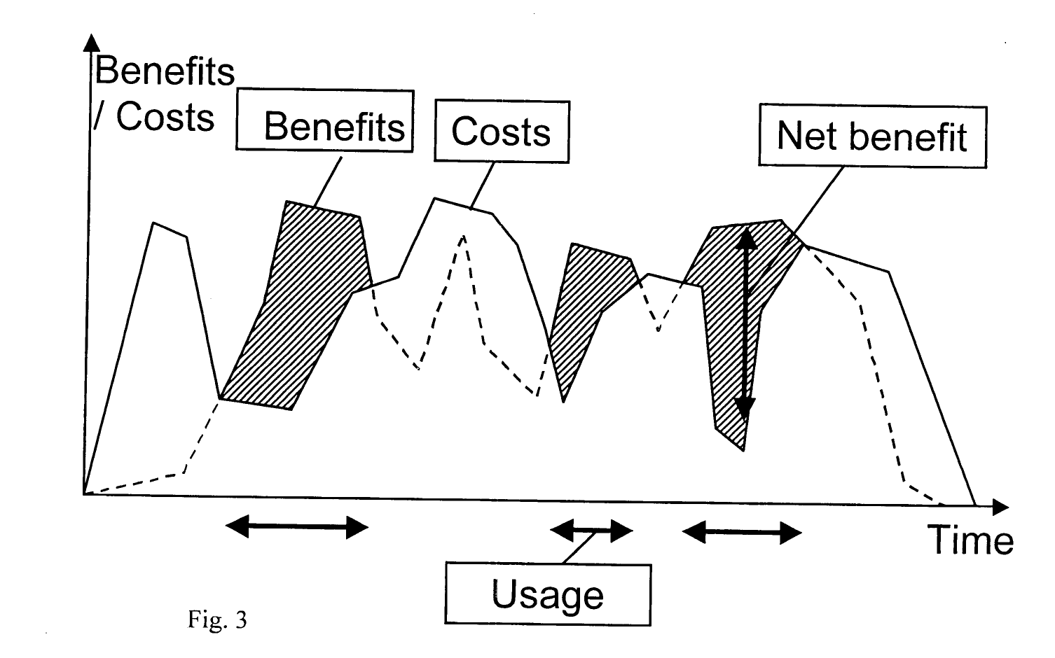

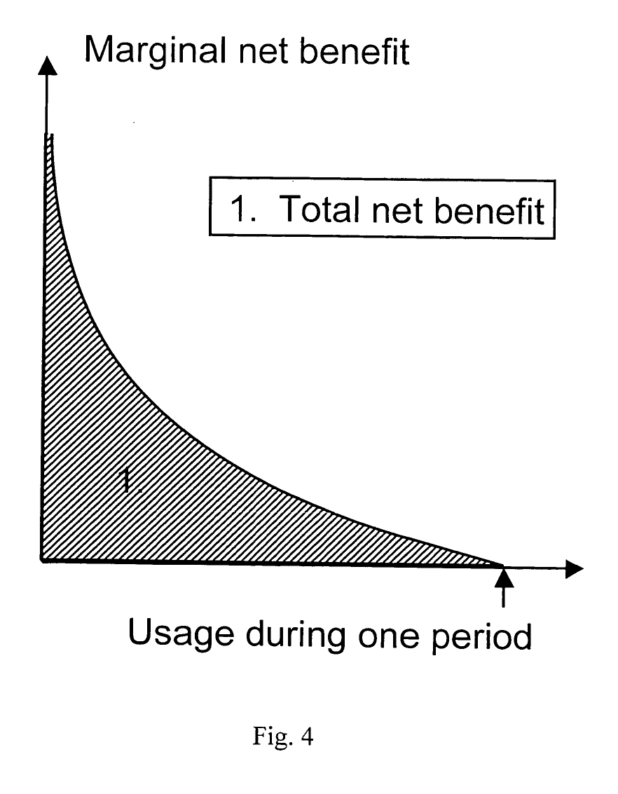

The goals of users may depend on many factors, such as age, education, or social customs. Thus users may have different needs and benefit from different things. For an individual user the value of a need, and thus the maximum benefit, may vary considerably with time and place as illustrated in FIG. 3. Furthermore, the benefits typically decrease as the user uses the service more. In other words, each additional unit of usage during a period of time commonly brings less benefit than the previous units. In economics, this is called diminishing marginal benefit.

Due to limited resources users have to decide which services to use and how much to use them. A rational user compares the benefits to be attained and the costs to be suffered, and will use the service if the benefits overcome the costs at that moment. That is,
Net benefit (t₁)=Benefits (t₁)−Costs (t₁)>0. (1)

As both benefits and costs are time dependent, net benefit also varies with time. User will use the service only when the net benefit is positive. It is noted that costs in formula (1) include the lost net benefit of the best alternative choice.

By arranging marginal net benefits—net benefit per unit of usage—from one period into the order of magnitude it may be possible to obtain the user's marginal net benefit curve for a service. By definition, the marginal net benefit declines with increasing usage, see FIG. 4. Area 1 below the marginal net benefit curve is the user's total net benefit from using a service during a period, for example a day, a week or a month.

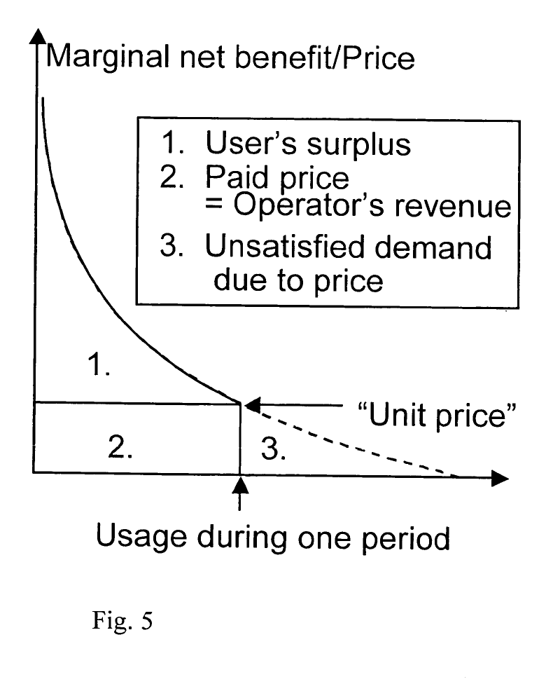

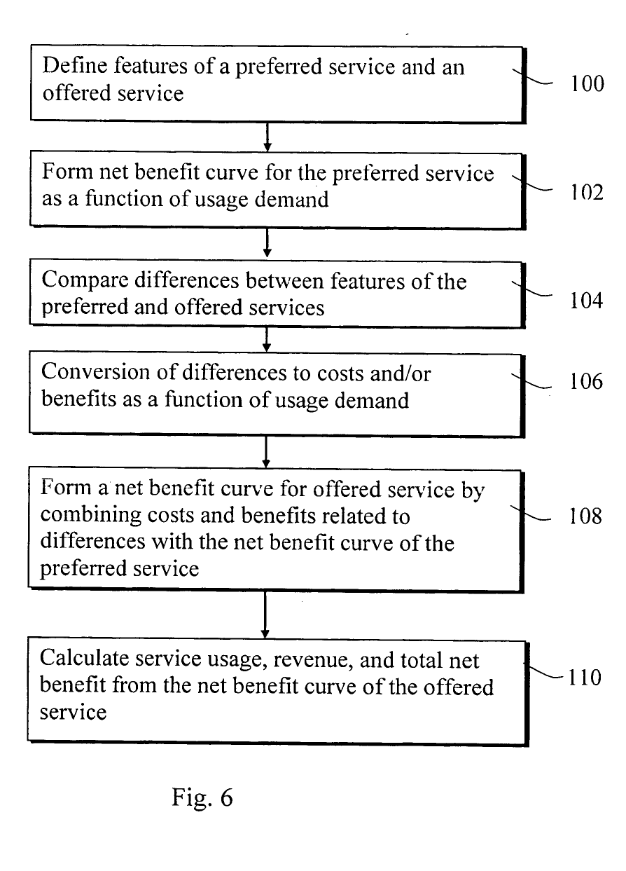

Lets now assume that the marginal net benefit curve does not include unit costs, for example a unit price. With a given unit price a user will use the service until the marginal net benefit of the “last” unit used is equal to its price. A marginal net benefit curve thus corresponds a demand curve of a service and gives the relationship between a unit price and usage for a particular service in particular circumstances, see FIG. 5.

However, the marginal net benefits of the “previous” units used are larger than the price and a user would be willing to pay more if he had to. The difference between what the user is willing to pay and the price the user actually paid, i.e., area 1 between the demand curve and price line, is the user's surplus from using the service. The user's surplus can be seen as a measure of the user satisfaction, and paid price is revenue for the service provider. The unit pricing causes also unsatisfied usage demand as illustrated by area 3 in FIG. 5. Usage demand refers to demanded quantities of resources, for example to number of calls, minutes of calls, megabytes transferred in a period.

By using an expert system of an embodiment, it may be possible for the service providers to optimize the design of the services. The analysis may be based on analysis of how a single user with given characteristics behaves when a specific end-user service with given characteristics is offered to him. Behavior may be expressed in terms of service usage and net benefit from service usage.

A situation wherein a user has identified a service that is able to satisfy his needs is considered first. This first service will be called hereinafter the preferred service. The usage of the preferred service is expected bring him both benefits and costs. These are given in a net benefit curve that includes these costs and benefits as a function of usage demand.

The other services offered to that user, may, however, differ from the preferred service. There can be differences in some or all features of the services. There may also be distinction whether the difference is expected or unexpected. These differences affect the costs and benefits the user gets from an offered service. Differences in costs and benefits can be absolute, or relative to cost and/or benefit depending on the characteristics of the feature.

Costs and benefits of all features affect together the net benefit that the user gets from the service usage. According to a possible scenario the user will use the offered service only if the net benefit from the usage thereof is positive. Changes in net benefit curve may thus affect usage of a service.

This situation may be analyzed by means of the following method. The analysis may initiate by a step of defining features of a preferred service and an offered service, see step 100 of FIG. 6. A net benefit calculation as a function of usage demand for the preferred service is then performed at step 102. This calculation may be based on input information such as costs and benefits. Step 102 is followed by a step 104 of comparison of all differences or predefined differences in features of the preferred and offered services. The differences are converted to absolute costs and benefits or costs and benefits relative to the preferred service as a function of usage demand at step 106. All costs and benefits may then be combined at step 108 with the net benefit curve of the preferred service. One net benefit curve for the offered service is thus formed. Values for service usage and total net benefit of a user may then be calculated at step 110 from the net benefit curve in accordance with appropriate economic considerations. Information regarding other aspects such as the revenue may also be calculated at this stage.

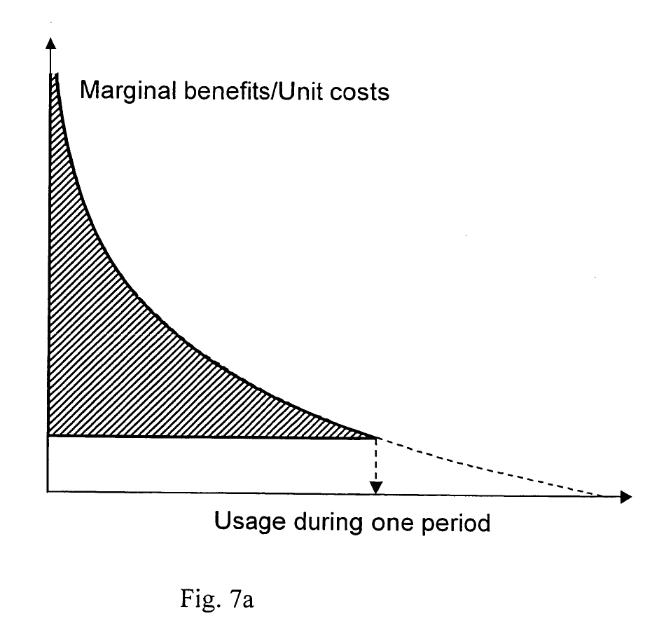

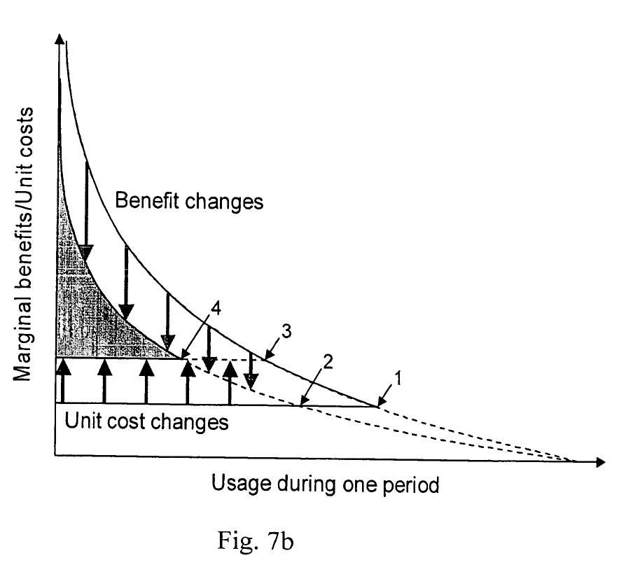

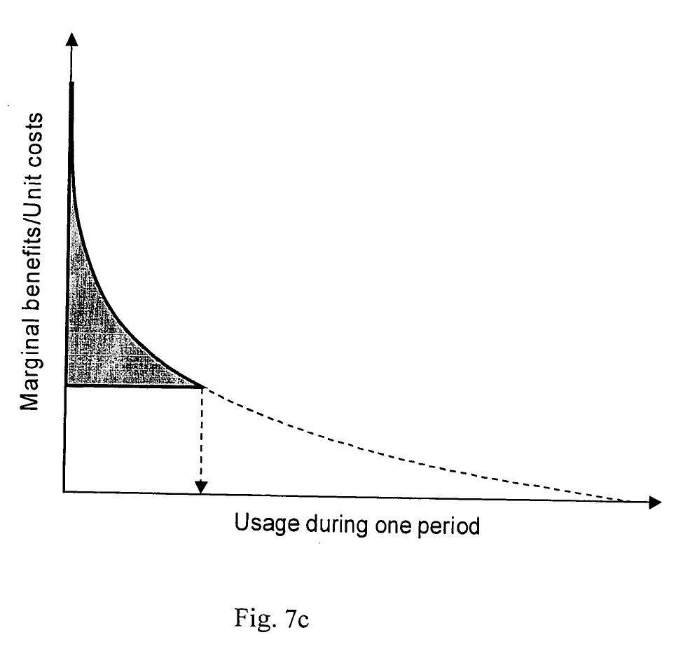

FIGS. 7a to 7c shows the change from a benefit and cost curve of a preferred service in FIG. 7a to a benefit and cost curve of an offered service in FIG. 7c due to comparison of costs and benefits. The curve of FIG. 7b shows the relative change (benefit) and absolute change (unit cost) as a result of comparison of a preferred and offered service. In FIGS. 7a to 7c the service usage is the point where the benefit curve crosses the cost curve. The total net benefit can be defined as fixed benefits−fixed costs+user's surplus. The user's surplus is shown as the shadowed area between the benefit curve and the cost curve. The net benefit curve is the difference between a benefit curve and a cost curve.

It may be assumed that a user uses the service as long as the net benefit from usage is positive, i.e. until the end of the shadowed area. If an offered service corresponds to several preferred services, the reference net benefit curve is the sum of net benefit curves of preferred services.

The net benefit curve may be used in analysing how different costs and benefits affect the usage and the user's net benefit from a service. Costs such as unit pricing and opportunity costs may be fixed for each unit used. Any increase of these costs will decrease the usage according to the net benefit curve (change from point 1 to point 3 in FIG. 7b). Some other costs, such as flat rate or bad user support, may not directly affect the usage of the service. Because the demand curve does not present these fixed costs, their effect to the total net benefit can be taken into account separately.

Benefit differences, e.g., due to limited service availability or bad quality of service, are typically relative to the benefit of the preferred service (see benefit change in FIG. 7b). Benefit change may change the usage together with a unit cost. For example, decreased benefit may decrease the usage until the marginal benefit from the “last” unit used corresponds to the unit cost. This is illustrated by the change from point 1 to point 2. The higher the unit cost, the larger the relative change. In this regard a reference can be made to the change from point 3 to point 4.

Changes in the network service quality affect the benefits a user gets from the service. Services suffer from different phenomena. Packet loss affects the packet switched voice and streaming, bit rate and delay may affect the data applications, and so on. Delays may be an important factor in applications such as online games. These changes in the technical quality parameters of a service used by the user should be transformed to lost or gained benefits for the net benefit analysis.

The benefit changes are typically proportional to the benefits of a preferred service. Empiric user researches can be used to find the correct transformations. Issues directly affecting the use of the service, like call blocking or limited coverage, may be taken into account in the other parts of the whole service analysis.

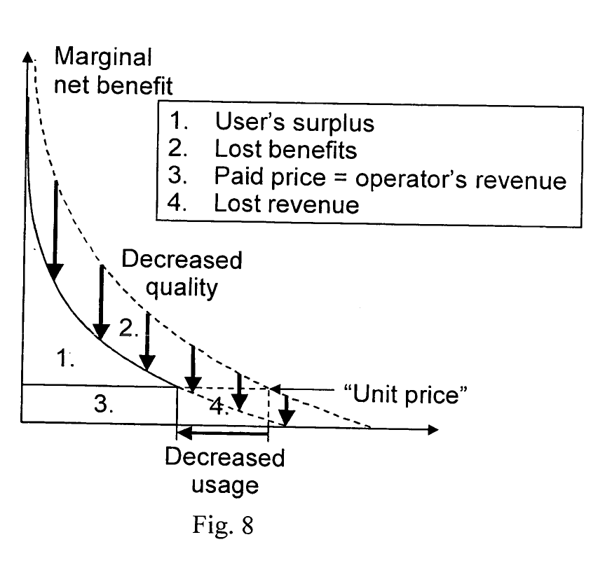

The service provider has several options to implement the pricing for a service. A typical pricing scheme is unit pricing where each used unit is charged by a fixed price. The unit can be based on time, volume, or number of pieces depending on the service. FIG. 8 shows how unit pricing together with decreased service quality may change the usage and surplus of the user.

Another pricing scheme is fixed or flat rate pricing. In this scheme a user pays a fixed monthly fee for the possibility to use the service. Fixed pricing does not add any unit cost for the service, and thus does not directly change the usage. It decreases, however, the available resources and thereby the opportunity cost, so that the usage of this specific service may even increase.

The required data processing functions may be provided by means of one or more data processor entities. Appropriately adapted computer program code product may be used for implementing the embodiments, when loaded to a computer, for example for performing the computations and for retrieving and analysing information.

The data processing may be provided by means of an external analyzer tool, such as the data processing device 14 of FIG. 1. The external analyzing tool may be used by service provider when designing and optimizing offered services and network. The analyzing tool may also be connected to a communication network to optimize some parameters thereof. The analyzing tool may also be useful for a user of services. In addition to individual users organizations, for example, companies or other big employers may use the expert system in the selection of service providers providing services to the employees. As an alternative of being provided in by means an external tool, the analysing system may be provided in a service provider server or in a user equipment.

The program code product may be stored on and provided by means of a carrier medium such as a carrier disc, card or tape. A possibility is to download the program code product via a data network.

Information regarding services that can be analysed may comprise various aspects of the service. For example, information regarding technical properties such as the screen size, a codec or sampling speed of a user equipment may be considered. The nature of content may be taken into account. Information regarding availability of services may be useful. For example, information regarding coverage of a network, and/or server availability, and/or signal blocking conditions may be utilised. Usability may be analysed based on information regarding activation delays, learning times, set up time of a service, and/or user interface. Consideration regarding pricing may also be performed. The pricing considerations may be based on information regarding the rates, such as charging variables relating flat rates, time rates, volume rates, transaction rates, time or volume block rates, and so on. Overall nature of the market may also have importance. This may be analysed based on information regarding service penetration, marketing, and knowledge and awareness of the service offering, price, nature of the service market, and quality. Quality aspects may be considered based on information regarding features such as bit rate, packet loss, jitter, delay, codec, drop rate, success rate and so on.

Information may be input in an analyser in various manners. It is possible to feed required data manually, for example by means of a keypad. An analyser may fetch at lest a part of the required information from an appropriate source, for example a service provider database. The analyser may be connected to a data network, and may be configured to retrieve at least a part of the required input information from a plurality of sources via the data network.

The following is an example of analysis of two services, more particularly mobile streaming and web browsing services. The considered service aspects are pricing and experienced service quality.

Definition of a Preferred Service:

| | Streaming | Web browsing |
|---|---|---|
| Technical | Terminal: | Terminal: |
| | cellular phone | cellular phone |
| properties | Screen size: | Screen size: |
| | 400 × 200 pixel | 400 × 200 pixel |
| Content | News and short | Internet content |
| | entertainment | |
| Availability | Always | Always |
| Usability | Instant service | Instant service |
| Quality | Bit rate 100 kbps | Bit rate 100 kbps |
| | Packet loss 0% | Packet loss 0% |
| | Delays 0 ms | Delays 0 ms |
| Price | 0 [symbol] /month | 0 [symbol] /month |

Net Benefit Curve for the Preferred Service:

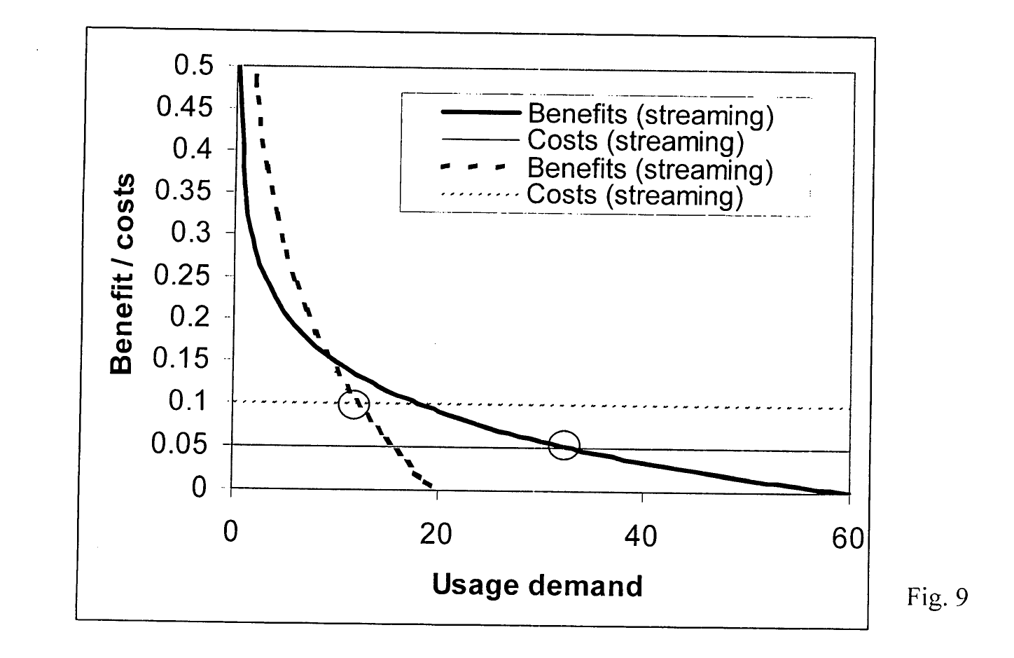

The net benefit curve for the preferred service is estimated based on user needs, capabilities, and resources. The curve is typically diminishing as a function of usage demand. In this example a negative logarithmic function is applied (ln(x) means natural logarithm of x). The curves are shown in FIG. 9.

Streaming

| | |
|---|---|
| Benefits (usage) = | −5/60 * ln(usage/60 min/day) |
| Costs (usage) = | 0.05 [symbol] /min |
| Total net benefit = | 2.7 [symbol] /day |
| Usage demand = | 33 min/day |

Web browsing

| | |
|---|---|
| Benefits (usage) = | −4/20 * ln(usage/20 min/day) |
| Costs (usage) = | 0.1 [symbol] /day |
| Total net benefit = | 2.4 [symbol] /day |
| Usage demand = | 12 min/day |

Net Benefit Curve for the Offered Service:

In the example the offered service have a price [symbol] 0.05/min and the service quality is not perfect; streaming suffers from average 10% packet loss (quite bad quality) and average bit rate for web-browsing is 80 kbps (moderate quality).

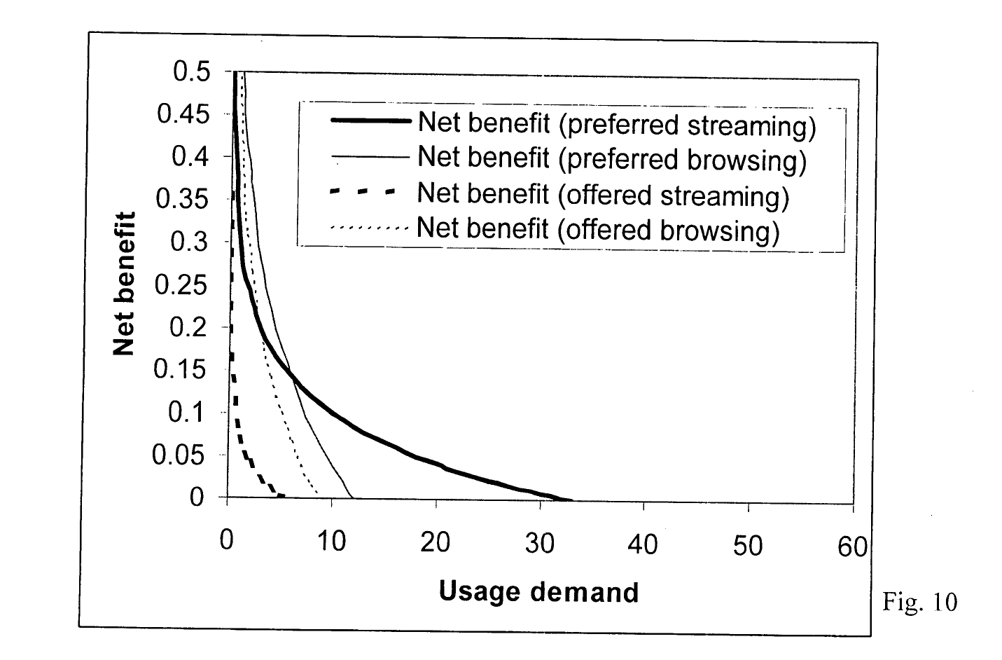

A user estimates that the quite bad quality of streaming decreases his benefits by 50% and lower bit rate of web-browsing decreases the web-browsing benefits by 10% compared to benefits from the preferred service. Resulting net benefit curves for offered services are seen in FIG. 10.

Streaming

| | |
|---|---|
| Price ΔNB (demand) = | 0.05 [symbol] /min |
| Service quality ΔNB (demand) = | 70% * Benefit |
| Net benefit (usage) = | 50% * (−5/60*ln (demand/60 min/ |
| | day)) − 0.05 − 0.05 [symbol] /min |

Web browsing

| | |
|---|---|
| Price ΔNB (demand) = | 0.05 [symbol] /min |
| Service quality ΔNB (demand) = | 90% * Benefit |
| Net benefit (usage) = | 90% * (−4/20 * ln (demand/20 min/ |
| | day)) − 0.10 − 0.05 [symbol] /min |

Usage of the service is determined by the point where the net benefit reaches zero. As can be seen from figure f, the quite bad quality of streaming decreases the uses from 33 minutes to 5 minutes per day and moderate quality of browsing from 13 minutes to 9 minutes per day. The total net benefit decreases from [symbol] 2.7/day to [symbol] 0.2/day and from [symbol] 2.4/day to [symbol] 1.6/day respectively. No fixed costs or benefits are considered.

It should be appreciated that whilst embodiments of the present invention have been described in relation to user equipment such as mobile stations communicating via a mobile system, embodiments of the present invention are applicable to any other suitable type of user equipment and communication systems.

The data is described as being in packet form. In alternative embodiments of the invention the data may be sent in any suitable format.

The embodiment of the present invention has been described in the context of a communication system comprising mobile networks and packet switched data networks. This invention is also applicable to any other communication systems including local area networks, fixed line networks as well as any hybrids of any appropriate networks.

It is also noted herein that while the above describes exemplifying embodiments of the invention, there are several variations and modifications which may be made to the disclosed solution without departing from the scope of the present invention as defined in the appended claims.

1. A method for analyzing services offered via a communication system, the method comprising the steps of:
determining a net benefit for a first service based on selected features of the first service;
determining differences between the selected features of the first service and selected features of a second service; and
determining a combined net benefit based on the net benefit of the first service and the differences between the selected features of the first and second services.

2. A method as claimed in claim 1, wherein the step of determining differences between the selected features of the first service and the second service comprises determining differences in terms of the net benefit.

3. A method as claimed in claim 1, further comprising determining the net benefit as a function of demand experienced by the first service.

4. A method as claimed in claim 1, further comprising determining the net benefit as a function of demand experienced by the second service.

5. A method as claimed in claim 3, further comprising quantifying the demand by means of a value of a parameter selected from a list of time of usage, amount of megabytes, or number of communication connections.

6. A method as claimed in claim 1, further comprising analyzing costs and benefits of using a service.

7. A method as claimed in claim 6, further comprising analyzing an absolute cost of the first or second service.

8. A method as claimed in claim 6, further comprising analyzing a relative cost of the first or second service.

9. A method as claimed in claim 6, further comprising analyzing an absolute benefit of the first or second service.

10. A method as claimed in claim 6, further comprising analyzing a relative benefit of the first or second service.

11. A method as claimed in claim 1, further comprising analyzing at least one following feature of services: technical properties, content, availability, usability, price, nature of a service market, and quality.

12. A method as claimed in claim 11, further comprising analyzing the technical properties based on information regarding at least one following property of a user equipment: screen size, codec, and sampling speed.

13. A method as claimed in claim 11, further comprising analyzing the availability based on information regarding network coverage, server availability or signal blocking conditions.

14. A method as claimed in claim 11, further comprising analyzing usability based on information regarding at least one of service activation delay, service learning time, service set up time, trouble, and user interface.

15. A method as claimed in claim 11, further comprising analyzing the price based on information regarding at least one charging variable of flat rate, time rate, volume rate, time or volume block rate, and transaction rate.

16. A method as claimed in claim 11, further comprising analyzing the nature of the service market based on information regarding at least one of service penetration, marketing, and knowledge.

17. A method as claimed in claim 11, further comprising analyzing the quality based on information regarding at least one of bit rate, packet loss, jitter, delay, codec, call dropping, and success rate.

18. A method as claimed in claim 1, further comprising the step of determining service usage for the second service.

19. A method as claimed in claim 1, further comprising the step of determining a net benefit provided by the second service for a user of services.

20. A method as claimed in claim 19, wherein the step of determining the net benefit comprises steps of determining a benefit function for the first or second service, determining a cost function for a service in comparable values, and determining values that are between the benefit function and cost function.

21. A method as claimed in claim 20, further comprising determining a total net benefit by adding fixed benefits and deducting fixed costs from the net benefit.

22. An analyzer for analyzing services offered via a communication system, the analyzer comprising:
a net benefit analyzer for determining a net benefit for a first service based on selected features of the first service;
a difference analyzer for determining differences between the selected features of the first service and selected features of a second service; and
a combiner for determining a combined net benefit based on the net benefit of the first service determined by the net benefit analyzer and the differences between the selected features of the first and second services determined by the difference analyzer.

23. An analyzer as claimed in claim 22, wherein the analyzer is provided in an external analysing tool.

24. An analyzer as claimed in claim 22, wherein the analyser is provided in a data processor operated by a service provider.

25. An analyzer as claimed in claim 22, wherein the analyzer is provided in a user equipment of a user of services.

26. A computer program embodied on a computer-readable medium, said program configured to control a computer to perform the steps of:
determining a net benefit for a first service based on selected features of the first surface;
determining differences between the selected features of the first service and selected features of a second service; and
determining a combined net benefit based on the net benefit of the first service and the differences between the selected features of the first and second services.

27. A system for analyzing services offered via a communication system, the system comprising:
first determining means for determining a net benefit for a first service based on selected features of the first service;
second determining means for determining differences between the selected features of the first service and selected features of a second service; and
third determining means for determining a combined net benefit based on the net benefit of the first service and the differences between the selected features of the first and second services.
